(19) United States
(12) Patent Application Publication
(10) Pub. No.: US 2014/0188530 A1
(43) Pub. Date: Jul. 3, 2014

(54) PROVISION OF CUSTOMER ATTRIBUTES TO AN ORGANIZATION

(71) Applicant: Wal-Mart Stores, Inc., Bentonville, AR (US)

(72) Inventor: David Patterson, Berkeley, CA (US)

(73) Assignee: Wal-Mart Stores, Inc., Bentonville, AR (US)

(21) Appl. No.: 13/730,454

(22) Filed: Dec. 28, 2012

(51) Int. Cl. G06Q 10/10

(52) U.S. Cl. CPC G06Q 10/10
USPC 705/7.11

(57) ABSTRACT

The present disclosure extends to methods, systems, and computer program products for establishing attributes representing a customer for distribution to recipients that are organizations. In operation, customer information is received and organized as attributes that are then made available to predetermined recipients.

### BACKGROUND

Advances in technology have allowed large amounts of information to be gathered in the form of data about the lives and behaviors of customers. A customer may wish to have this information made available to various organizations so that the customer may be represented as part of a population in an organizations analysis and marketing efforts.

What is needed are methods and systems that are efficient at organizing relevant information about customers' lives, and also effective methods and systems to convey this information in a form that is both private for the customer and useful for the organization. As will be seen, the disclosure provides methods and systems that can do this in an efficient and elegant manner.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example retail location and computer architecture that facilitates different implementations described herein;

FIG. 3 illustrates a flow chart of an example method according to one implementation;

FIG. 4 illustrates a flow chart of an example method according to one implementation;

FIG. 5 illustrates a flow chart of an example method according to one implementation; and

FIG. 6 illustrates a flow chart of an example method according to one implementation.

### DETAILED DESCRIPTION

The present disclosure extends to methods, systems, and computer program products for conveying information about customer attributes based on customer provided information and other related information from the customer's activity on a merchant's networks or within a merchant's retail location that may represent an approximate estimation of the customer's life. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

As used herein, the terms “customer” and “user” are used interchangeably, and are intended to denote that a customer can be both contemplated in a brick and mortar retail location as well as a customer who is a user on a computing device.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

As used herein, the terms “life history” are intended to represent customer attributes over time that may be used by the customer to convey information about the customer's life over time. A life history, may be represented by attributes that span the known life of the customer, or may represent only a portion of the customer's life. It should be noted that a life history does not have to include all the attributes of a customer, but may contain selected attributes or filtered attributes, such that a customer can control the level of detail and personal information conveyed in a life history.

As used herein, the term “provision” is intended to represent the act of providing access (either electronic or physical) to customer attributes to a recipient, whether it is the actually conveyance of attributes (either physically or electronically) to a recipient or allowing access to the attributes over a network.

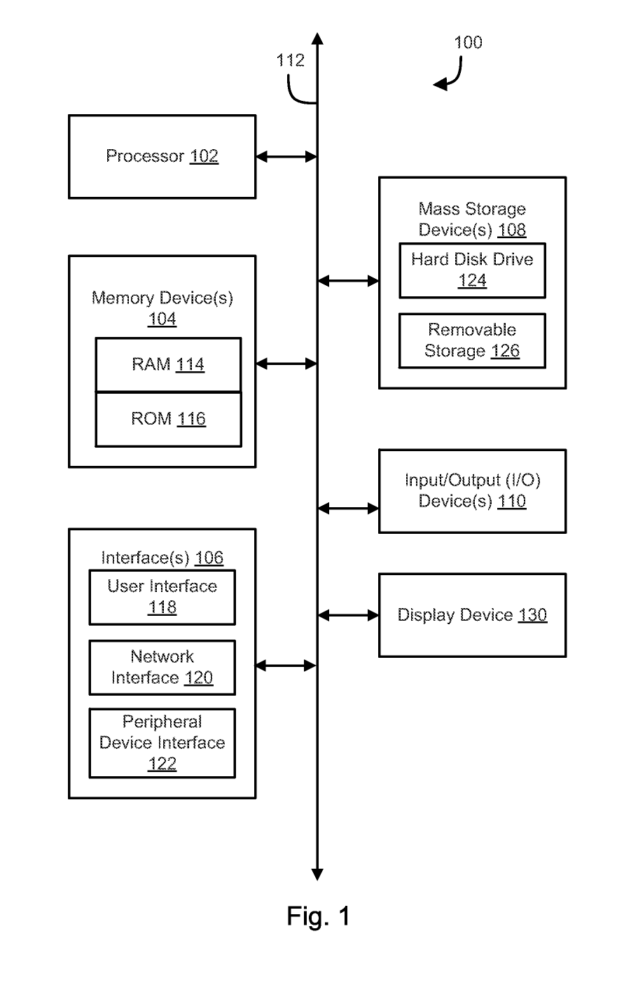

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

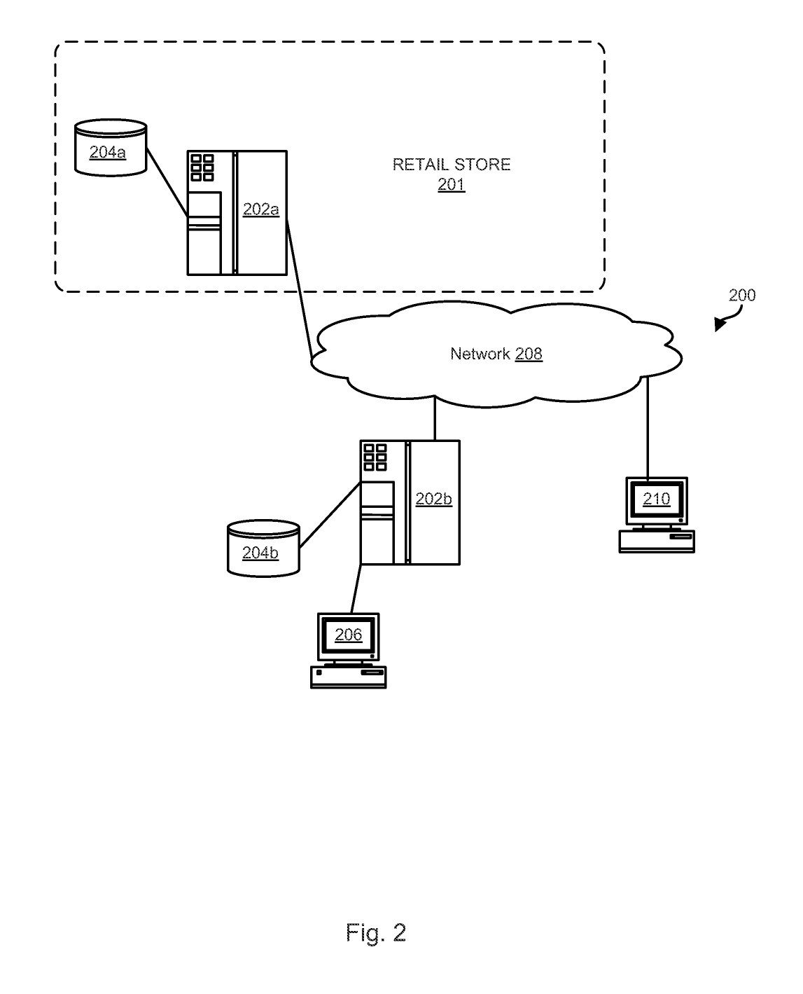

FIG. 2 illustrates an example of a computing environment 200 and a brick and mortar retail location 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity or party providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

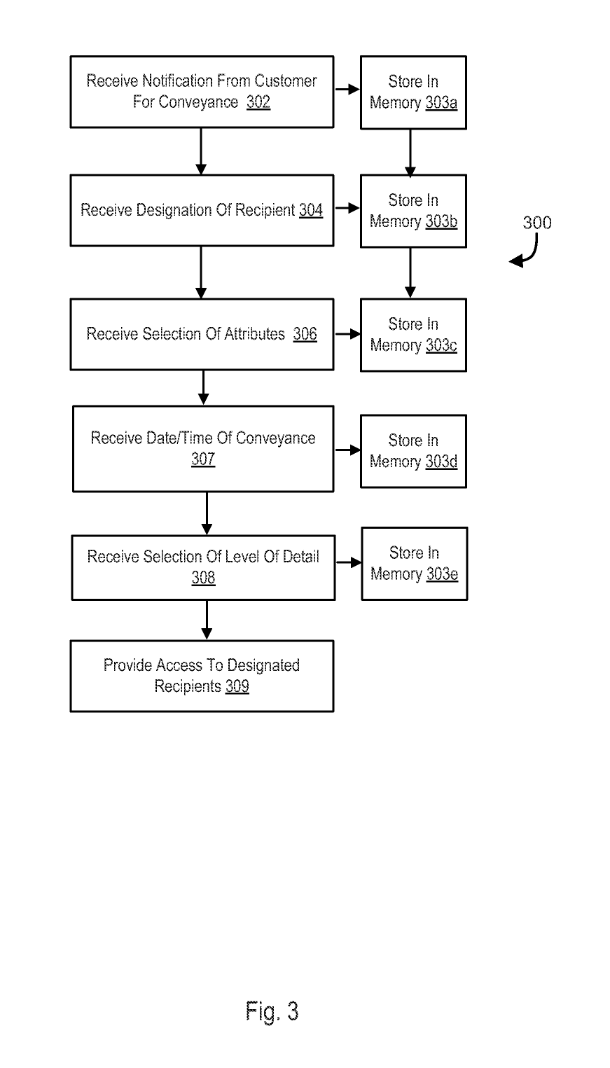

With reference primarily to FIG. 3, an implementation of a method 300 for creating a selection of attributes suitable for conveying customer attributes to a designated organization (recipient) will be discussed. FIG. 1 and FIG. 2 may be referenced secondarily during the discussion in order to provide hardware support for the implementation. The disclosure aims to disclose methods and systems to allow a customer to designate a recipient of a selection of attributes filled with attributes, that when assembled, form a version of the customer's life and activities suitable for conveyance to the designated recipient. An organization may be a recipient that studies customer attributes, or otherwise analyses customer attributes in order to provide information and insight about customers. Organizations may be limited by laws regarding the information that can be used or kept by an organization. For example, an organization may not legally store and use information that specifically identifies the action of a customer. In other words, modern laws may protect customers' privacy by limiting the level of information that an organization may use with regard to specifically identifying a customer.

The method 300 may include the database 204a (or any suitable memory device disposed in communication with the network 208) receiving notification 302 from a customer that the customer would like to convey, or allow access to, the customer's attributes to a third party recipient. At 303a the notification may be stored in memory associated with a customer profile within computing environment 200. The notification by the customer may be solicited by a merchant, and may be received over a computer network that both the customer and merchant are connected to. Additionally, the notification may be made in person at a retail location of the merchant. Either on-line or in-store, a database 204a (or any suitable memory device disposed in communication with the network 208) used in performing the method 300 may receive a designated recipient organization 304 to whom a selection of attributes of attributes can be distributed.

The designation of the recipient by the customer may be made by directly communicating with a representative of the merchant in real time or with a communication device to enable delayed communication such as via email or other suitable communication means, or on-line from a web page type interface having input and output options as discussed above.

In an implementation, the selection of attributes may comprise the notification recorded into memory at 303a within computing environment 200, along with the designation of the recipient, recorded into memory at 303b within computing environment 200.

At 306, the customer may also determine a list of possible attributes to be organized within a selection of attributes for the designated recipient that may portray the actions and life of the customer and may include such things as: identities, documents, images of the customer, home address, work history, and/or any other type of attribute information normally used to establish a snapshot of a person's life and activities. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The designation of a recipient at 304 and the selection of attributes made by a customer may be stored in memory 303b and 303c within computing environment 200. The attributes may have been entered by the customer previously, or may be entered concurrently with the notification for conveyance at 302. In an implementation, attributes that may be used may be from documents provided by the customer that have been saved in the memory on a merchant's server within the computing environment 200. Furthermore, a customer may wish to have the attributes organized in a certain way within the selection of attributes. For example, a selection of attributes may be predetermined such that it contains such information as: age, education, income, image of customer, gender of customer, home ownership, and/or marital status. An implementation, may comprise a selection of attributes that contains documents, or portions of documents, where the customer specifies the type and order of the documents in the selection of attributes. Accordingly, it can be seen by those in the art, that a selection of attributes conveying a any portion of a customer's life, may be small or may be very large, and that a selection of attributes can vary depending on the desires of the customer and characteristics of the designated recipient.

At 307, a date and time for conveyance may be received from a customer and recorded into memory 303d of the computing environment 200. In the present implementation a customer may designate when its attributes may be accessed and used by the recipient. For example, a customer may desire to have its attributes be represented during a political season and not at other times of the year such that a possible recipient may be a polling organization. As such, the customer may set the date of access and level of detail to correspond to typically desired polling information and times. In the present example the selected attributes to be conveyed may comprise: age, education, political affiliation, income, image of customer, gender of customer, home ownership, and/or marital status. Additionally, in the present example a date for conveyance may be made during an election year. As can be seen in the example, a customer may be given control over the attributes, recipients, and the time at which the information is conveyed.

At 308, a desired level of attribute detail may be received from the customer and recorded into memory 303e of computing environment 200. In addition to the control provided thus far by the method 300, in an implementation a customer may designate a level of detail that is to be conveyed. In other words, it is a feature of the present disclosure to provide a customer with the ability to specify a level, or a plurality of levels, of detail to share with a designated organization. The desirable level of detail a customer may wish to convey may depend on the use that a recipient may put the attributes to. For example, a user may wish to provide more detail and personal information for political purposes and less detail for marketing purposes. The level of detail may correspond to an amount of privacy, such that the higher the level of detail designated the more private and precise the attributes that are conveyed to a recipient.

Once the selection of attributes has been established as discussed above, the method may involve the process of the computing device 100 within a computing environment 200 then filling in the selection of attributes with the desired attributes representing a customer at 308. At 309, access may then be granted to the designated recipient at the time and date received at 307. It should be noted, that recipients may be allowed to access the attribute information of a customer on the merchant's sever over connected networks, or alternatively, the merchant may actually convey the selection of attributes to the recipients such that the recipients have the selection of attributes within their own computer system.

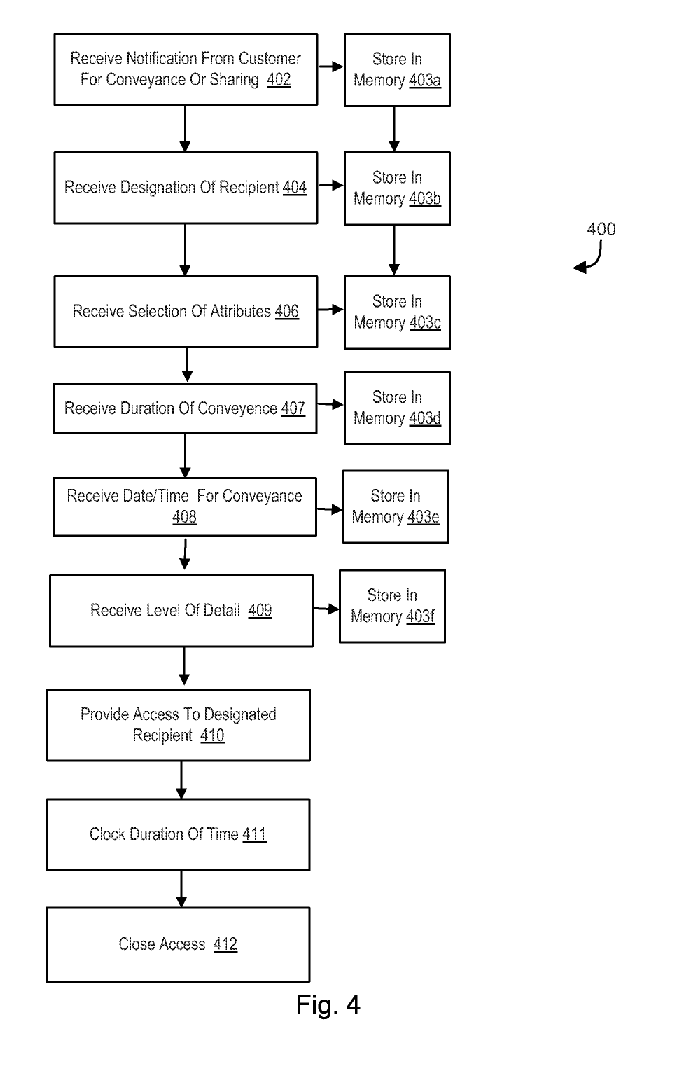

With reference primarily to FIG. 4, an implementation of a method 300 for creating a selection of attributes suitable for conveying customer attributes to a designated organization (recipient) will be discussed. FIG. 1 and FIG. 2 may be referenced secondarily during the discussion in order to provide hardware support for the implementation. The disclosure aims to disclose methods and systems to allow a customer to designate a recipient of a selection of attributes filled with attributes, that when assembled, form a version of the customer's life and activities suitable for conveyance to the designated recipient for a specified duration of time.

The method 400 may include the database 204a (or any suitable memory device disposed in communication with the network 208) receiving notification 402 from a customer that the customer would like to convey, or allow access to, the customer's attributes to a third party recipient. At 403a the notification may be stored in memory associated with a customer profile within computing environment 200. The notification by the customer may be solicited by a merchant, and may be received over a computer network that both the customer and merchant are connected to. Additionally, the notification may be made in person at a retail location of the merchant.

Either on-line or in-store, a database 204a (or any suitable memory device disposed in communication with the network 208) used in performing the method 400 may receive a designated recipient 304 to whom a selection of attributes of attributes can be distributed. The designation of the recipient by the customer may be made by directly communicating with a representative of the merchant in real time or with a communication device to enable delayed communication such as via email or other suitable communication means, or on-line from a web page type interface having input and output options as discussed above. In an implementation, the selection of attributes may comprise the notification recorded into memory at 403a within computing environment 200, along with the designation of the recipient, recorded into memory at 403b within computing environment 200.

At 406, the customer may also determine a list of possible attributes to be organized within a selection of attributes for the designated recipient that may portray the actions and life of the customer and may include such things as: identities, documents, images of the customer, home address, work history, and/or any other type of attribute information normally used to establish a snapshot of a person's life and activities. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The designation of a recipient at 404 and the selection of attributes made by a customer may be stored in memory 403b and 403c within computing environment 200. In an implementation, the attributes may have been entered by the customer previously, or may be entered concurrently with the notification for conveyance at 402. In an implementation, attributes that may be used may be from documents provided by the customer that have been saved in the memory on a merchant's server within the computing environment 200.

Furthermore, a customer may wish to have the attributes organized in a certain way within the selection of attributes. For example, a selection of attributes may be predetermined such that it contains such information as: age, education, income, image of customer, gender of customer, home ownership, and/or marital status. An implementation, may comprise a selection of attributes that contains documents, or portions of documents, where the customer specifies the type and order of the documents in the selection of attributes. Accordingly, it can be seen by those in the art, that a selection of attributes conveying any portion of a customer's life, may be small or may be very large, and that a selection of attributes can vary depending on the desires of the customer and characteristics of the designated recipient.

At 407, a duration of time that the designated recipients are allowed access may be specified by the customer and recorded into memory 403d within environment 200. It should be noted, that third party recipients may be allowed to access the attribute information of the customer, or alternatively, the merchant may actually convey the selection of attributes to the recipients such that the recipients receive a file on to their computer that is connected over the network 208. In either happenstance, once the duration has elapsed, access to the attribute data is to be terminated. In an implementation where the attributes are conveyed in a selection of attributes, the selection of attributes file may simply be deleted to terminate access. Any suitable manner known to those skilled or having ordinary skill in the field, for terminating a third party recipient's access to the attribute data, such when the duration specified or designated by the customer has occurred, may be used. In an implementation where access is granted to a third party recipient, the access may simply be denied once the duration of time has elapsed. In an implementation, access by the designated recipient may depend on non-time related factors, such as, whether the customer continues to work at the work place. Accordingly, if the customer were to change places of work the customer may wish to stop access to the selection of attributes by the previous coworkers.

At 408, a date and time for conveyance may be received from a customer and recorded into memory 403e of the computing environment 200. In the present implementation a customer may designate when its attributes may be accessed and used by the recipient. For example, a customer may desire to have its attributes to be represented during a political season and not at other times of the year so that a possible recipient may be a polling organization. As such, the customer may set the date of access and level of detail to correspond to typically desired polling information and times. In the present example the selected attributes to be conveyed may comprise: age, education, political affiliation, income, image of customer, gender of customer, home ownership, and/or marital status. As can be seen in the example, a customer may be given control over the attributes, recipients, and the time at which the information is conveyed.

At 409, a desired level of attribute detail may be received from the customer and recorded into memory 403f of computing environment 200. In addition to the control provided thus far by the method 400, in an implementation a customer may designate a level of detail that is to be conveyed. In other words, it is a feature of the present disclosure to provide a customer with the ability to specify a level, or a plurality of levels, of detail to share with a designated organization. The desirable level of detail a customer may wish to convey may depend on the use that a recipient may put the attributes to. For example, a user may wish to provide more detail and personal information for political purposes and less detail for marketing purposes. The level of detail may correspond to an amount of privacy such that the higher the level of detail designated the more private and precise the attributes that are shared to a recipient.

At 410, access may then be granted to the designated recipient at the time and date received at 408 and for the duration specified at 407. It should be noted, that recipients may be allowed to access the attribute information of a customer on the merchant's sever over connected networks, or alternatively, the merchant may actually convey the selection of attributes to the recipients such that the recipients have the selection of attributes within their own computer system. Additionally, access may be granted on the specified date 408 to the designated recipients, and at 411 a clock begins to run for the duration of time designated at 407 of method 400. The clock may run automatically within the computing system of a network and the clock may be a commonly used timing circuit within the computing environment 200. At 412, access to the selection of attributes may be closed to the third party recipients once the duration of time has elapsed as discussed above. Any suitable manner known to those skilled or having ordinary skill in the field, for terminating a recipient's access to the attribute data, such when the duration specified by the customer has occurred, may be used.

It should be noted that the life history attributes may have been entered by the customer previously, or may be entered concurrently with the notification for conveyance at 402. In an implementation, attributes that may be used in a selection of attributes may be derived from documents provided by the customer that have been saved previously in the memory on a merchant's server located within computing environment 200.

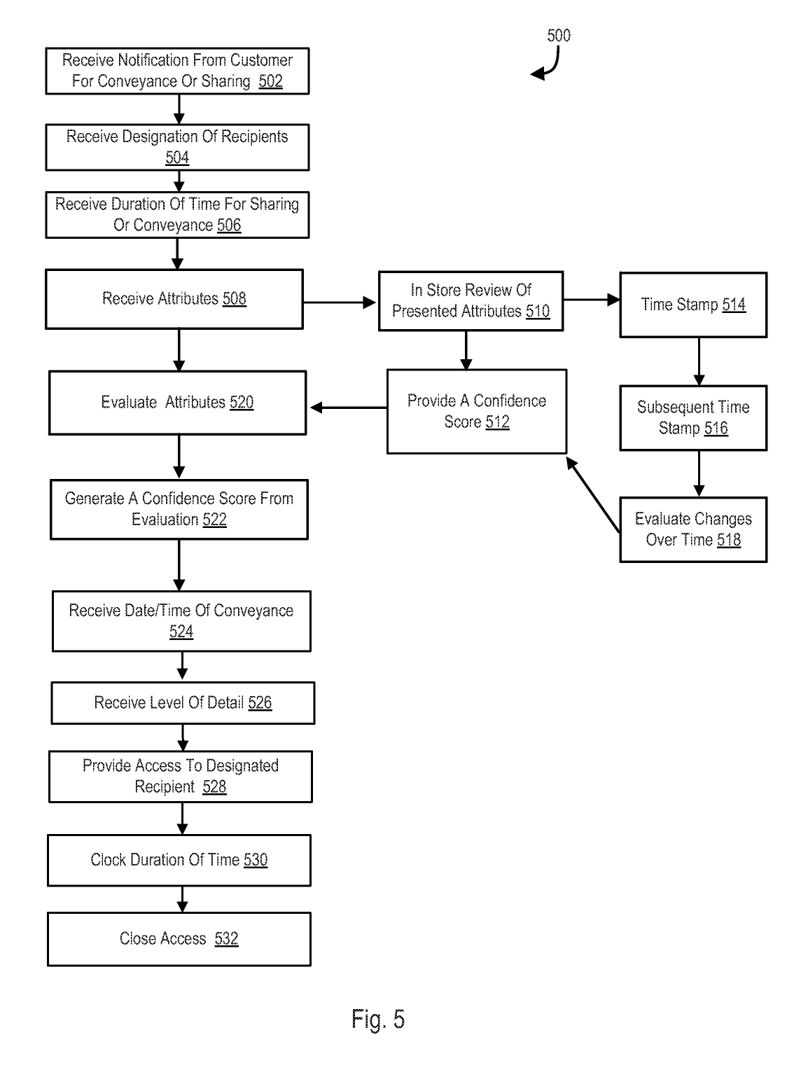

With reference primarily to FIG. 5, an implementation of a method 500 for creating a selection of attributes for conveying customer attributes in a selection of attributes that represents a life history that may be evaluated over time for the quality of the attributes within the selection of attributes will be discussed. FIG. 1 and FIG. 2 may be referenced secondarily during the discussion in order to provide hardware support for the implementation, and the connections and interrelatedness within the networking and computing relationships described above in discussion of FIG. 3 are hereby deemed to apply to the following descriptions in relation to FIG. 5.

Accordingly, the method 500 may include receiving notification 502 from a customer that the customer would like to convey, or allow access to, the selection of attributes. The notification by the customer may be solicited by a merchant, and may be received over a computer network that both the customer and merchant are connected to. Additionally, the notification may be made in person at a retail location of the merchant in real time or with a communication device to enable delayed communication such as via e-mail or other suitable communication device, or on-line from a web page type interface having input and output options as discussed above. Either on-line or in-store, the method 500 may receive a designation or selection of recipient organizations 504 and store the designated recipients in memory within computing environment 200.

In an implementation, the customer may be designating the desired third party recipients from a list presented to them by a merchant. The designation by the customer may be made by directly communicating with a representative of the merchant, or may be made on-line from a web page type interface having input and output options as discussed above. As discussed above, the customer may determine a selection of attributes of desired attributes to be conveyed to specific recipients based on characteristics of the recipients (or relation to the recipients) and the nature of information that the customer would like to share with such recipients.

At 506, a duration of time (or other limiting factor) that the designated recipients are allowed access to the selection of attributes may be specified by the customer and recorded into memory. It should be noted, that recipients may be allowed to access the selection of attributes of a user, or alternatively, the merchant may actually provision and convey the selection of attributes to the recipients. In either happenstance, once the designated limiting factor has elapsed, access to the selection of attributes is to be terminated.

At 508 of method 500, attributes may be input into the system, or selected by a customer, or by receiving attribute information from other sources within the computing environment 200. In an implementation, various documents may be presented by a customer either in person at a retail location, or on-line wherein the attribute information is presented digitally. Furthermore, the attribute information from a customer may be digital in form and may comprise digital copies of such things as: State issued ids, legal documents, images of the customer, utility bills, home address, work history, pay check stubs, car registrations, and/or any other type of attribute information normally used to establish a person's identity. Additionally, a customer at a computer terminal may be able to enter attribute data in order to fill-in fields that represent the selection of attributes to be conveyed within a selection of attributes. The information provided, either digitally or in the retail location, may then be reviewed 510 for content and quality. The review may be performed by a system and/or a representative of the merchant.

For a non-limiting example, a utility bill may be presented by a customer to provide attributes, and a digital copy may be received from the customer over the network 208. A merchant representative or a computer and/or server may review 510 the utility bill for customer attribute information and store the information on a merchant's server. The evaluation may be to authenticate the utility bill as real, and/or gather information from the utility bill such as name, address, usage, length of time for billing relationship, and other like information. In the present example, the system may then generate a confidence score 512 for the utility bill based on the review 510, and then enter the confidence score into the selection of attributes at the time the selection of attributes is established at 524 of method 500.

It is also a feature and aspect of the present disclosure to provide the ability for a merchant to track how customer attributes may change over time. Accordingly, method 500 may provide the feature of tracking change over time, by comparing attribute information received into the system at a time stamp 514, to additional attribute information received into the system at a subsequent time stamp 516.

At 514, the attribute data received into the system may be time stamped in order to provide the additional information about when a customer has entered attribute information. Time stamp data can be used to provide timeliness information about a customer for such uses as, for example, providing timely recommendations for seasonal items and services. At 516, subsequent time stamp data may be associated with additional attribute information received by the system.

At 518, the attribute change between the time stamp of 514 and 516 may be evaluated for quality and recorded in memory within computing environment 200 for later use by the system, or within the selection of attributes. The information provided by a customer and the attribute change data provided at 518 may then be evaluated 520 for quality such that a confidence score may be assigned 522 based on the quality of the attributes and the change of the attributes overtime.

At 524, a date and time for conveyance may be received from a customer and recorded into memory of the computing environment 200. In the present implementation a customer may designate when its attributes may be accessed and used by the recipient. For example, a customer may desire to have its attributes to be represented during a political season and not at other times of the year so that a possible recipient may be a polling organization. As such, the customer may set the date of access and level of detail to correspond to typically desired polling information and times. In the present example the selected attributes to be conveyed may comprise: age, education, political affiliation, income, image of customer, gender of customer, home ownership, and/or marital status. As can be seen in the example, a customer may be given control over the attributes, recipients, and the time at which the information is conveyed.

At 426, a desired level of attribute detail may be received from the customer and recorded into memory of computing environment 200. In addition to the control provided thus far by the method 500, in an implementation a customer may designate a level of detail that is to be conveyed. In other words, it is a feature of the present disclosure to provide a customer with the ability to specify a level, or a plurality of levels, of detail to share with a designated organization. The desirable level of detail a customer may wish to convey may depend on the use that a recipient may put the attributes to. For example, a user may wish to provide more detail and personal information for political purposes and less detail for marketing purposes. The level of detail may correspond to an amount of privacy such that the higher the level of detail designated the more private and precise the attributes that are shared to a recipient.

Additionally, the selection of attributes may comprise the notification received at 502 recorded into memory within computing system 200, the designated recipients recorded into memory, and the duration of access recorded into memory, change over time information, a confidence score regarding the change over time, and a confidence score for attribute quality. In an implementation, it may be desirable for the merchant to provide the confidence scores within the selection of attributes, while in another implementation the confidence score may not be provided to customer or any third party recipients.

At 528, access may then be granted to the designated recipients and at 530 a clock begins to run for the duration of time designated at 506 of method 500. The clock may run automatically within the computing system of a network and the clock may be a commonly used timing circuit within the computing system. At 532, access to the selection of attributes may be closed once the duration of time has elapsed as discussed above. In an implementation wherein a plurality of recipients is designated, each of the recipients may have different limitations of access to the selection of attributes, such that the method may comprise a plurality of limiting factors that determine when access is closed for each recipient. Accordingly, the limiting factor for each recipient may be recorded in memory and associated with the provision of the selection of attributes for each recipient. In other words a plurality of selection of attributes containing the same life history attributes may be established so that there is a selection of attributes for each recipient.

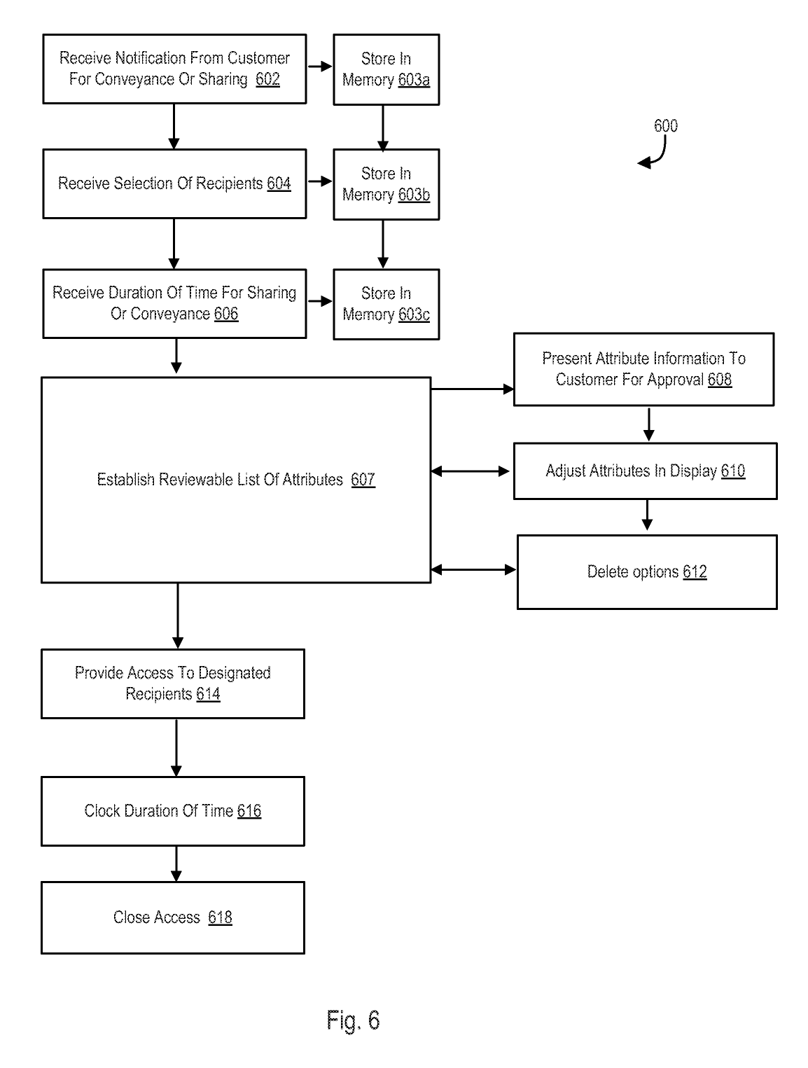

With reference primarily to FIG. 6, an implementation of a method 600 for creating a selection of attributes for conveying customer attributes to an organization will be discussed. FIG. 1 and FIG. 2 may be referenced secondarily during the discussion in order to provide hardware support for the implementation, and the connections and interrelatedness within the networking and computing relationships described above in discussion of FIG. 3 are hereby deemed to apply to the following descriptions in relation to FIG. 4. The disclosed implementation aims to disclose methods and systems to allow customer attributes to be organized into a useable format within a selection of attributes that can be conveyed to a third party as directed by a user or customer. Additionally, the customer may visually organize the information of the selection of attributes as desired.

Accordingly, the method 600 may include the process of receiving notification 602 from a customer that the customer would like to convey, or allow access to, the customer's attributes. At 603a, the notification may be stored in memory within the computing system 200 associated with a customer profile. The notification by the customer may be solicited by a merchant, and may be received over a computer network that both the customer and merchant are connected to. Additionally, the notification may be made in person at a retail location of the merchant in real time or with a communication device to enable delayed communication such as via e-mail or other suitable communication device, or on-line from a web page type interface having input and output options as discussed above. Either on-line or in-store, the method 600 may receive a selection of recipients 604.

In an implementation, the customer may be selecting the desired recipients from a list presented to them by a merchant. The selection by the customer may be made by directly communicating with a representative of the merchant, or may be made on-line from a web page type interface having input and output options as discussed above. The customer may also determine list of possible attributes, that may be derived from customer items previously received and reviewed by the merchant, to be conveyed that may include such things as: identities, legal documents, images of the customer, utility bills, home address, work history, pay check stubs, car registrations, and/or any other type of attribute information normally used to establish a person's identity. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. At 604 the selection made by a customer for the third party recipients they wish to allow access to, is received and stored in memory 603b of computing environment 200.

At 606, a duration of time that the designated third party recipients are allowed access is received from the customer and recorded into memory 603c within computing environment 200. It should be noted, that recipients may be allowed to access the attribute information of a user, or alternatively, the merchant may actually convey the attributes to the third party recipients. In either happenstance, once the duration designated by the customer has elapsed, access to the attribute data is to be terminated.

At 607, a reviewable list of selected attributes may be generated. It should be noted that a selection of attributes may comprise attributes and items in various forms as discussed above. For example, a selection of attributes may be presented to a customer (or user, if the customer is not directly involved in an implementation) for review and approval at 608 of method 600. The presentation may be performed by a computer display within computing environment 200 whereby a customer is shown how the customer attributes appear in the selection of attributes established at 607. After the customer has viewed the selection of attributes, the customer may adjust or organize the selection of attributes 610 to better convey the attributes of the customer as desired. The adjustment 610 may be performed through any I/O devices as discussed above, and may provide a ‘what you see is what you get’ arrangement so that a customer and third party see the same organization of attributes. In an implementation, a customer may be able to delete 612 attributes they do not want to be conveyed within the selection of attributes to a third party recipient by graphically removing them on the display.

In an implementation, several iterations may be performed to allow a customer to fine tune the selection of attributes, for example, a customer may make an adjustment 610 to the selection of attributes and then be presented with the adjusted selection of attributes for review and approval 608, or the selection of attributes may be reestablished 607 after a deletion 612 of an attribute for a subsequent review and approval 608. Once the customer or user has the selection of attributes in a desirable form access may then be granted 614 to the designated third party recipients and at 616 a clock begins to run for the duration of time designated at 606 of method 600. The clock may run automatically within the computing system of a network and the clock may be a commonly used timing circuit within the computing system. At 618, access to the selection of attributes may be closed once the duration of time has elapsed as discussed above.

Thus the disclosure provides a method and system for establishing a selection of attributes for conveying customer attributes by considering the nature of the usage by a third party organization. Additionally, the disclosure allows a customer to specify the form of the selection of attributes, the date it is conveyed, and the duration that it is conveyed, before it is shared to a designated third party. The disclosure also provides for the selection of attributes to comprise confidence scores and levels of detail for the attributes therein, and allows attributes of the selection of attributes to be evaluated over time.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for providing attributes for access by a recipient, comprising:
receiving a notification from a customer requesting that an attribute in a customer profile that is representative of that customer be made available to a recipient;
receiving from the customer a designation of a recipient for access;
storing the designation of the recipient in memory of a server;
receiving from the customer selection of attributes to be conveyed to the recipient;
receiving from the customer designated time of conveyance from the customer;
receiving from a customer a selection of level of detail of attributes to convey to the recipient;
wherein the level of detail selected influences the attributes representing the customer that are conveyed; and
providing access to the attributes according to the level selected by the customer at the designated time of conveyance to the recipient.

2. A method according to claim 1, further comprising receiving a duration of access that the customer would like the attributes to be available for access by the recipient.

3. A method according to claim 2, further comprising denying access to the attributes of the recipient when the duration of access has elapsed.

4. A method according to claim 1, further comprising receiving a number of accesses that the recipient is allowed to access the attributes.

5. A method according to claim 4, further comprising denying access to the recipient when the recipient has accessed the attributes equal to the number accesses specified by the customer.

6. A method according to claim 1, wherein the attributes are predetermined to comprise the following attributes: age of customer, education of customer, income of customer, location of the customer, gender of customer.

7. A method according to claim 1, wherein the attributes are predetermined to comprise the following attributes: age of customer, education of customer, income of customer, home ownership of customer, marital status.

8. A method according to claim 1, further comprising:
presenting to the customer a selectable selection of customer items that contain customer attributes that have been provided by the customer;
receiving a selection of customer items made by the customer; and
evaluating the items selected by the customer for customer attributes.

9. A method according to claim 1, further comprising: organizing the attributes on a display such that the recipient is presented with the attributes in the same layout that is displayed on the display as viewed by the customer.

10. A method according to claim 1, further comprising:
evaluating the attributes for quality;
providing a confidence score corresponding to quality and providing the recipients access to the confidence score.

11. A system for providing customer attributes for access by a recipient, comprising: one or more processors and one or more memory devices operably coupled to the one or more processors and storing executable and operational data, the executable and operational data effective to cause the one or more processors to:
receive a notification from a customer requesting that an attribute in a customer profile that is representative of that customer be made available to a recipient;
receive from the customer a designation of a recipient for access;
store the designation of the recipient in memory of a server;
receive from the customer selection of attributes to be conveyed to the recipient;
receive from the customer designated time of conveyance from the customer;
receive from a customer a selection of level of detail of attributes to convey to the recipient;
wherein the level of detail selected influences the attributes representing the customer that are conveyed; and
provide access to the attributes according to the level selected by the customer at the designated time of conveyance to the recipient.

12. A system according to claim 11, further comprising receiving a duration of access that the customer would like the attributes to be available for access by the recipient.

13. A system according to claim 12, further comprising of denying access to the recipient when the duration of access has elapsed.

14. A system according to claim 11, further comprising receiving a number of accesses that the recipient is allowed to access the attributes.

15. A system according to claim 14, further comprising denying access to the recipient when the recipient has accessed the attributes equal to the number accesses specified by the customer.

16. A system according to claim 11, wherein the attributes are predetermined to comprise the following attributes: age of customer, education of customer, income of customer, location of the customer, gender of customer.

17. A system according to claim 12, wherein the attributes are predetermined to comprise the following additional attributes: age of customer, education of customer, income of customer, home ownership of customer, marital status.

18. A system according to claim 11, further comprising:
present to the customer a selectable selection of customer items that contain customer attributes that have been provided by the customer;
receive a selection of customer items made by the customer; and
evaluate the items selected by the customer for customer attributes.

19. A system according to claim 11, further comprising: organize the attributes by the customer on a display such that the recipient is presented with the attributes in the same layout that is displayed on the display as viewed by the customer.

20. A system according to claim 11, further comprising:
evaluate the attributes for quality;
provide a confidence score corresponding to quality and providing the recipients access to the confidence score.
